(19) United States
(12) Patent Application Publication
(10) Pub. No.: US 2014/0055415 A1
(43) Pub. Date: Feb. 27, 2014

(54) TOUCH RECOGNITION SYSTEM AND METHOD FOR TOUCH SCREEN

(71) Applicant: HYUNDAI MOTOR COMPANY, Seoul (KR)

(72) Inventor: Sung Un Kim, Hwaseong (KR)

(73) Assignee: HYUNDAI MOTOR COMPANY, Seoul (KR)

(21) Appl. No.: 13/688,136

(22) Filed: Nov. 28, 2012

(30) Foreign Application Priority Data
Aug. 22, 2012 (KR) 10-2012-0091595

(51) Int. Cl. G06F 3/042

(52) U.S. Cl. CPC G06F 3/0425
USPC 345/175

(57) ABSTRACT

Disclosed herein is a touch screen recognition method. The method includes photographing an image of, an infrared ray pattern and a periphery of the pattern using an infrared ray camera disposed on a rear surface of the touch screen. A reference clarity value is set for the pattern image and the periphery thereof. A touch manipulation is recognized when pressure is exerted on the touch screen and a change in brightness of the clarity value is detected by comparing an image clarity value and the reference clarity value of the touched portion.

### CROSS-REFERENCE

This application claims under 35 U.S.C.§119(a) the benefit of Korean Application No. 10-2012-0091595 filed Aug. 22, 2012, the entire contents of which is incorporated herein by reference.

### BACKGROUND

1. Field of the Invention

The present invention relates to touch screen technology, and more particularly, to a touch screen recognition method using an infrared ray, which may recognize a curved touch on a curved or flexible display and increase the accuracy and reliability of touch recognition.

2. Description of the Related Art

Currently, resistive, capacitive, and optical methods are typically used in touch recognition technology. An example of such a method is one based on a liquid crystal display (LCD) display using a touch recognition sensor mounted onto an LCD or a touch recognition electrode.

However, the current touch recognition methods are designed to operate on a substantially level touch screen surface, and cannot be operated on a curved surface design such as in an interior member or component of a vehicle. Although a flexible touch screen display has recently been developed, this display is manufactured in a substantially level surface process. Additionally, there remain physical limitations to developing a curved surface on a flexible structure. The use of an infrared camera has been suggested for use in multi-touch recognition methods as well, but existing methods using an infrared ray are vulnerable to external noise caused by scattering light, which causes an error during touch recognition.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made in an effort to solve the above-described problems associated with prior art. The present invention proposes a touch screen recognition method which may operate on a curved or flexible display, recognize a curve touch, and increases both reliability and accuracy of touch recognition.

In one embodiment, the present invention proposes a touch screen recognition method, using: an image photographing step whereby an infrared ray pattern and a periphery of the pattern is photographed using an infrared ray image generation device, e.g., camera, video camera, etc., disposed on, for example, a rear surface of the touch screen. Additionally, to recognize a touch manipulation, a reference clarity value of the pattern image and the periphery thereof is set by, e.g., a processor or controller installed therein. When pressure is exerted on the touch screen, a change in a brightness of the clarity value is detected by comparing an image clarity value and the reference clarity value of the touched portion, resulting in a touch manipulation.

In a preferred embodiment, recognizing a touch includes setting a critical clarity value to recognize whether pressure is exerted on the touch screen. Furthermore, a manipulated touch is detected/identified when an image clarity value of the touched portion of the pattern or the periphery of thereof becomes brighter than the reference clarity value, exceeding the critical clarity value.

In another embodiment, the reference clarity value is set to correspond to brightness of the exterior surroundings of the touch screen.

In still another embodiment, the clarity value is set to gradually increase or decrease according to a gray color level found in the infrared pattern image as pressure is exerted on the touch screen.

In a further embodiment, a resilient elastic layer is disposed on a surface of the touch screen to increase the precision of detecting a touch intention by recognizing finger displacements of a user.

According to above-described the touch recognition method, as an object such as a finger, approaches the touch screen, the pattern or the image around the pattern turns brighter and the reference clarity value exceeds the preset critical clarity value, whereby a touch is recognized. A touch may therefore be recognized on a curved surface as on object approaches a display such as a multimedia display device and a manipulation system. Multimedia display devices may thus be designed ergonomically according to the location of the display in a vehicle, creating an increase in device placement options.

In addition, by using a resistive touch method, a touch may be recognized through a gloved hand and the like as well as a finger. In particular, a touch may be recognized despite existing external optical noise, substantially increasing the reliability of the device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view illustrating changes in clarity values before and after a touch occurs on the display screen according to an exemplary embodiment of the present invention;

FIG. 2 is an exemplary view illustrating infrared ray resistive patterns responsive to touch on the display screen according to an exemplary embodiment of the present invention; and

FIG. 3 is an exemplary view illustrating a change in brightness of the pattern responsive to touch on the display screen according to an exemplary embodiment of the present invention and experimental results of overall brightness changes.

It should be understood that the appended drawings are not necessarily to scale, presenting a somewhat simplified representation of various preferred features of the basic principles of the invention. The specific design features of the present invention as disclosed herein, including, for example, specific dimensions, orientations, locations, and shapes will be determined in part by the particular intended application and use environment.

### DESCRIPTION OF PREFERRED EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although the below exemplary embodiments are described as using a plurality of units to perform the above process, it is understood that the above processes may also be performed by a single controller or unit. Additionally, it is well understood that a single processor or a plurality of processors may be utilized to execute each of the above described units. Accordingly, these units may be embodied as hardware or software which is executed by a processor or controller.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, an exemplary embodiment of the present invention will be described in detail with reference to the accompanying drawings.

A touch screen recognition method of the present invention, illustrated with reference to FIGS. 1 to 3, includes an image photographing step wherein the touch screen is a rear projection display, showing an infrared ray pattern. In this embodiment, the touch screen 10 displays an infrared ray pattern 12 reacting to pressure on the touch screen 10. An image and the periphery thereof of the pattern 12 is photographed using an infrared ray camera 20 disposed on the rear surface of the screen. A touch is recognized by detecting a change in brightness of a set reference clarity value of the image and a reference clarity value of the touched portion. The infrared pattern 12 may be formed so that it is visually unrecognizable, and may reduce screen quality noise in the image.

The infrared camera 20 is disposed on a rear side of the touch screen 10 substantially spaced apart from the display, and photographs a change in clarity value of the pattern 12 and the periphery of the pattern 12 when pressure is exerted on the touch screen 10. An infrared illumination 22 may be installed on a lateral side of the infrared camera 20 to irradiate an infrared ray to photograph the infrared patter 12 using the infrared camera 20. Here, the infrared illumination 22 may be an infrared LED.

A projector 24 may be further installed to be substantially spaced apart from the display at a rear side of the touch screen 10, and the projector 24 projects an image to the touch screen 10 visible on the display.

When a user applies pressure to the touch screen 10, the clarity of the infrared pattern 12 provided in the touch screen 10 and the image at the periphery of the pattern 12 is changed, and a touch is recognized.

In addition, in the present invention, a resilient elastic layer 14 may be disposed on a surface of the touch screen 10 to detect a touch pressure. Here, the elastic layer 14 may be formed of a transparent material, and the pattern formed on a surface of the elastic layer 14 may be photographed through the infrared camera 20 when pressure is exerted on the touch screen 10.

A displacement of a finger may be generated when a user touches the touch screen 10 using a certain amount of force. This force may be any force that is necessary to perceive that the user is touching the screen. Thus, by providing an elastic film layer on the touch screen 10, a touch pressure may be detected and calculated through measurement of a displacement distance, and a genuine touch intention of the user may be determined.

In the present invention, determining a touch manipulation includes arbitrarily setting a critical clarity value to recognize whether the touch screen 10 is touched. A touch is recognized when an image clarity value of the touched portion is changed brighter than the reference clarity value, exceeding the set critical clarity value.

That is, the critical clarity value is set to a value brighter than the clarity value when no pressure is detected on the touch screen 10. The critical clarity value is set to a value of higher brightness than the clarity value of a touched touch screen when pressure is detected Accordingly, if the touch screen 10 is touched, it is determined that a touch manipulation occurs when a clarity value of the touched portion changes to a higher brightness exceeding the set critical clarity value.

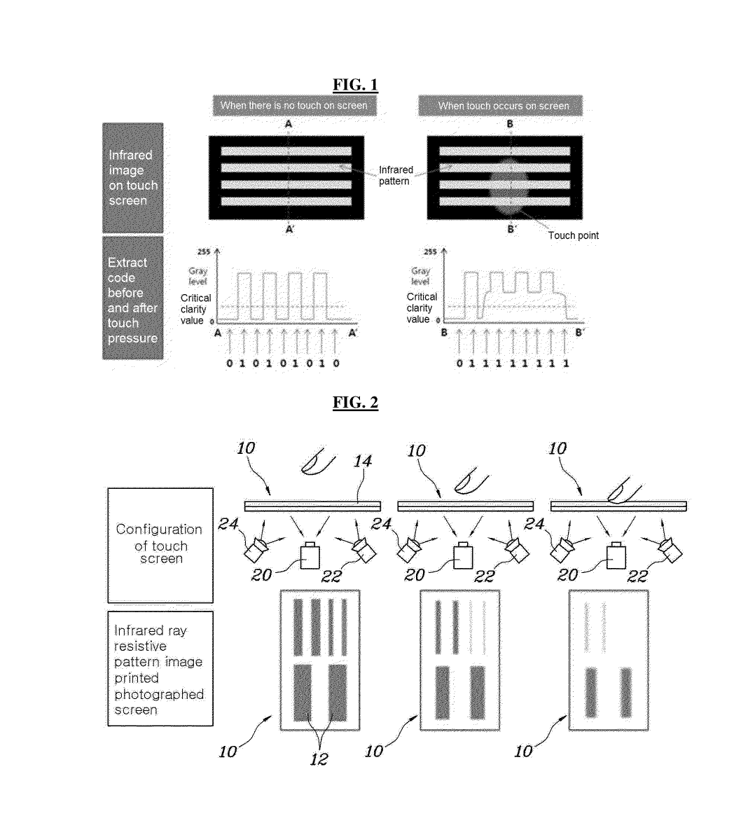

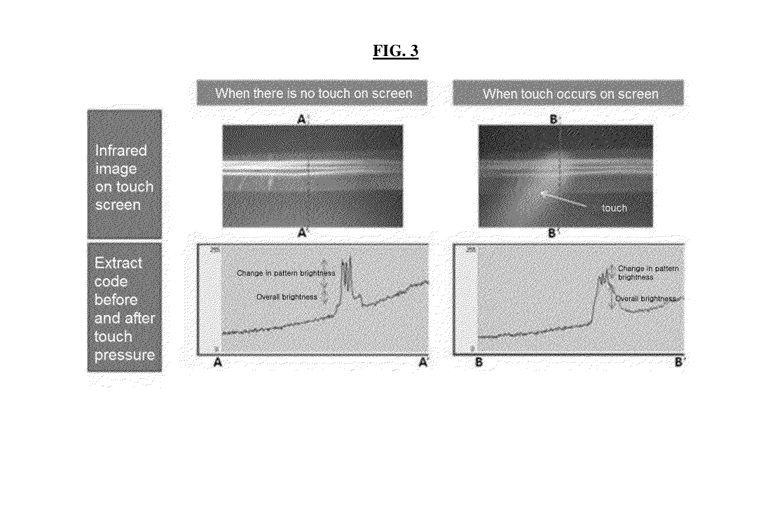

Referring to FIG. 2, in more detail, as an object, e.g. a finger or a ballpoint pen, moves closer to the touch screen, more scattered reflections occur, blurring the infrared pattern 12 formed on the touch screen 10. Thus, when an object exerts pressure on the touch screen 10, the touched portion becomes brighter, whereby a touch is recognized. In addition, in identifying touch recognition, it may be determined that a touch is manipulated when the image clarity value of the touched pattern 12 or the periphery of the pattern 12 exceeds a critical clarity value by becoming brighter.

As an example, as illustrated in FIG. 1, an image clarity value of the pattern 12 is detected to be brighter than the critical clarity value before a touch is made, whereas an image clarity value surrounding the touched pattern 12 is photographed and determined to be darker than the critical clarity value. Thus, when the image clarity value surrounding the pattern 12 becomes brighter than the critical clarity value when a touch is made, it is recognized as a touch manipulation.

In the present invention, the reference clarity value may be set to correspond to brightness of the exterior surroundings of the touch screen. In particular, when the touch screen 10 is touched, a clarity value of the pattern 12 and the periphery of the pattern 12 becomes a reference clarity value, and a touch is recognized when a change in the reference clarity value is detected.

However, as illustrated in FIG. 3, a large brightness change in the pattern 12 exists before the touch screen 10 is touched, while the overall brightness of the image around the pattern 12 increases when pressure is applied to the touch screen 10, reducing the brightness change of the pattern 12. Thus, even when optical noise surrounding the touch screen 10 is introduced, the overall brightness change is substantially unaffected.

As illustrated in FIG. 1, the clarity value may be set to gradually increase or decrease according to a gray level in the infrared pattern image. The gray level represents a change in the black and white color of the infrared pattern image On the gray level scale, white color is represented by the number 0 and black color is represented by the number 256. A clarity value may be set to a value of 1 to 255 according to gray color level in the infrared pattern image.

According to above-described the touch screen recognition method, as an object moves closer to the touch screen 10, the pattern 12 or the image around the pattern 12 becomes brighter, causing the reference clarity value to exceed the preset critical clarity value, whereby a touch is recognized. Furthermore, according to the touch screen recognition method, the displays of a multimedia device and a manipulation system may be curved, whereby display face may be ergonomically designed for an application in, e.g. a vehicle.

In addition, by using a resistive touch method for recognizing pressure on a touch screen 10, a touch manipulation by various objects such as a ball pen, a gloved hand, a finger and the like may be recognized. Furthermore, a touch may be accurately recognized despite existing external optical noise, causing a significant increase in reliability of the device.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A touch screen recognition method, comprising:
photographing, by an image generation device, an image of an infrared ray pattern and a periphery of the pattern using an infrared ray camera disposed on a rear surface of the touch screen;
setting, by a processor, a reference clarity value of the pattern image and the periphery thereof; and
identifying, by a processor, a touch manipulation by detecting a brightness change of the reference clarity value, wherein the brightness change is a comparison of an image clarity value and the reference clarity value of the touched portion.

2. The touch screen recognition method of claim 1, wherein detecting a brightness change of the reference clarity value includes:
arbitrarily setting a critical clarity value configured to recognize a pressure on the touch screen; and
identifying touch manipulation when the brightness change of the image clarity value of the touched portion exceeds the critical clarity value.

3. The touch recognition method of claim 2, wherein the touch manipulation exists when the image clarity value of the infrared ray pattern or the periphery of the pattern exceeds the critical clarity value.

4. The touch recognition method of claim 1, wherein the reference clarity value is set to correspond to brightness of an exterior surrounding of the touch screen.

5. The touch recognition method of claim 1, wherein the clarity value is set to gradually increase or decrease according to a gray color level in the infrared pattern image.

6. The touch recognition method of claim 1, wherein a resilient elastic layer is disposed on a surface of the touch screen configured to detect the pressure on the touch screen.

7. A system comprising:
an image generation device configured to photograph an image of an infrared ray pattern and a periphery of the pattern using an infrared ray camera disposed on a rear surface of the touch screen;
a processor configured to set a reference clarity value of the pattern image and the periphery thereof, and identify touch manipulation by detecting a brightness change of the reference clarity value, wherein the brightness change is a comparison of an image clarity value and the reference clarity value of the touched portion.

8. The system of claim 7, wherein the processor is further configured to, during detection of a brightness change of the reference clarity value, arbitrarily set a critical clarity value configured to recognize a pressure on the touch screen, and identify touch manipulation when the brightness change of the image clarity value of the touched portion exceeds the critical clarity value.

9. The system of claim 8, wherein the touch manipulation exists when the image clarity value of the infrared ray pattern or the periphery of the pattern exceeds the critical clarity value.

10. The system of claim 7, wherein the reference clarity value is set to correspond to brightness of an exterior surrounding of the touch screen.

11. The system of claim 7, wherein the clarity value is set to gradually increase or decrease according to a gray color level in the infrared pattern image.

12. The system of claim 7, wherein a resilient elastic layer is disposed on a surface of the touch screen configured to detect the pressure on the touch screen.

13. A non-transitory computer readable medium containing program instructions executed by a process, the computer readable medium comprising:
program instructions that instruct an image generation device to photograph an image of an infrared ray pattern and a periphery of the pattern using an infrared ray camera disposed on a rear surface of the touch screen;
program instructions that set a reference clarity value of the infrared pattern image and the periphery thereof; and
program instructions that identify a touch manipulation by detecting a brightness change of the reference clarity value, wherein the brightness change is a comparison of an image clarity value and the reference clarity value of the touched portion.

14. The non-transitory computer readable medium of claim 13, further comprising program instruction that, during detection of a brightness change of the reference clarity value, arbitrarily set a critical clarity value configured to recognize a pressure on the touch screen, and identify touch manipulation when the brightness change of the image clarity value of the touched portion exceeds the critical clarity value.

15. The non-transitory computer readable medium of claim 14, wherein the touch manipulation exists when the image clarity value of the infrared ray pattern or the periphery of the pattern exceeds the critical clarity value.

16. The non-transitory computer readable medium of claim 13, wherein the reference clarity value is set to correspond to brightness of an exterior surrounding of the touch screen.

17. The non-transitory computer readable medium of claim 13, wherein the clarity value is set to gradually increase or decrease according to a gray color level in the infrared pattern image.

18. The non-transitory computer readable medium of claim 7, wherein a resilient elastic layer is disposed on a surface of the touch screen configured to detect the pressure on the touch screen.
